(19) United States
(12) Patent Application Publication
(10) Pub. No.: US 2016/0377344 A1
(43) Pub. Date: Dec. 29, 2016

(54) ENCAPSULATED INSULATING MODULE FOR FURNACES

(71) Applicant: NUTEC BICKLEY, S.A. DE C.V., Santa Catarina (MX)

(72) Inventors: Francisco MALDONADO-CUEVA, Santa Catarina (MX); Alberto CANTU-PEREZ, Santa Catarina (MX)

(21) Appl. No.: 14/750,091

(22) Filed: Jun. 25, 2015

(51) Int. Cl. F27D 1/00

(52) U.S. Cl. CPC F27D 1/0033; F27D 1/00

(57) ABSTRACT

An encapsulated insulating module for furnaces composed by two different quality materials, in which a regular quality insulating module is encapsulated or surrounded by a high quality insulating layer, wherein the regular quality insulating module is in direct contact with the surface of a hot portion of a furnace wall.

### BACKGROUND OF THE INVENTION

A. Field Of The Invention

The present invention is related to insulating systems for furnaces and kilns and more particularly to an encapsulated insulating module for furnaces composed by two different quality materials, in which a regular quality insulating module is encapsulated or surrounded by a high quality insulating layer, wherein the regular quality insulating module is in direct contact with the surface of a hot portion of a furnace wall.

B. Background of the Invention

There are well known the furnace wall constructions composed by fiber insulation modules.

Generally, the furnace wall constructions such as those used in forge furnaces, comprises several fiber insulation modules retained to a mesh by anchoring means and attached to a support structure.

Each fiber insulating module is comprised by a ceramic fiber mat which is normally rolled in order to provide the insulating module with a greater density and better insulating characteristics. Each module is then attached to the surface of the hot face of the furnace wall. It is important to note that each module is made of the same material which must be of high quality—and expensive—in order to endure the hot temperatures of the furnace wall.

In order to lower the cost of an insulating system, it would be necessary to use less material for each module, or to use regular quality material, but obviously at the cost of reducing the quality and performance of the insulating module.

Therefore, it would be desirable to have an insulating module which could be more economical while at the same time maintaining the same quality and performance of the high cost modules.

Applicant found that it is not necessary to provide the module with the same high quality material, since when taking the temperature of the material, the greater the distance from the hot face of the furnace, the lower the temperature. Therefore, it is possible to use a lower quality material

In view of the above, applicant developed an insulating module comprised by two different quality materials: a module made of a regular quality ceramic mat contacting the hot surface of the furnace wall—which comprise most of the module material—and a surrounding layer made of a high quality ceramic mat which surrounds the first module, thus completely isolating the first module and compensating for it lower insulating performance.

The second module surrounds the first module, therefore, it is only necessary to provide sufficient high quality material to surround the first module thus lowering the cost of the module while providing the same performance as the traditional insulating modules which are formed by high density insulating material since the high quality insulating “cover”, complements the regular quality insulating module below.

The insulating system developed by applicant achieves the same insulating performance as the traditional insulating systems at a lower cost while maintaining the same width.

### SUMMARY OF THE INVENTION

It is therefore a main object of the present invention to provide an insulating system comprised by two different quality insulating modules: a first module made of a regular quality ceramic mat contacting the hot surface of the furnace wall—which comprise most of the module material—and a second module made of a high quality ceramic mat which surrounds the first module, thus completely isolating the first module and compensating for it lower insulating performance.

It is another object of the present invention, to provide an insulating system of the above described nature in which The second module surrounds the first module, therefore, it is only necessary to provide sufficient high quality material to surround the first module thus lowering the cost of the module while providing the same performance as the traditional insulating modules which are formed by high density insulating material since the high quality insulating “cover”, complements the regular quality insulating module below.

It is an additional object of the present invention to provide an insulating system of the above described nature which achieves the same insulating performance as the traditional insulating systems at a lower cost while maintaining the same width.

### BRIEF DESCRIPTION OF THE DRAWINGS

FIG. 1 is a lateral view of a first embodiment of the encapsulated insulating module for furnaces of the present invention.

FIG. 2 is a lateral view of a second embodiment of the encapsulated insulating module for furnaces of the present invention.

FIG. 3 is a lateral view of a third embodiment of the encapsulated insulating module for furnaces of the present invention.

### DETAILED DESCRIPTION OF THE INVENTION

The invention will now be described referring to a preferred embodiment thereof, illustrated in the accompanying drawings wherein the same signs and numbers, refer to the same parts of the shown figures.

The encapsulated insulating module of the present invention comprises:

an internal module 1 made of a regular quality ceramic fiber, preferably formed by folding an individual ceramic fiber strip or blanket, which is in unfolded condition, in a manner doubling the ends over on themselves forming “U” shaped turns, said internal module having: a hot surface portion 2 contacting the hot surface of a furnace wall, a cold surface portion 3 opposite to the hot surface portion, a first lateral surface portion 4 and a second lateral surface portion 5;

an external layer 6 made of a high quality, high performance ceramic fiber, formed by a ceramic fiber strip or blanket having a first portion 7 surrounding the cold surface portion 3 of the internal module 1, a second portion 8 surrounding the first lateral surface portion 4 of the internal module 1, and a third portion 9 surrounding the second lateral surface portion 5 of the internal module 1;

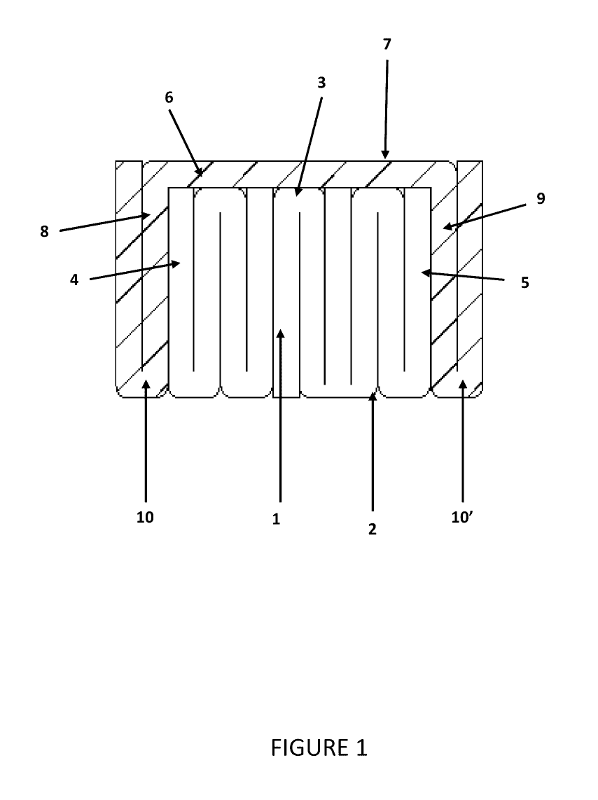

The portions of the external layer 8, 9 that surround the first lateral surface portion 4 and the second lateral surface portion 5 of the internal module may be long enough to be folded over themselves in one or more “U” shaped turns 10, 10′ as shown in FIG. 1.

The material of the encapsulated insulating module is preferably comprised by approximately 65% of a regular quality ceramic fiber and a 35% of a high quality ceramic fiber, i.e the internal module comprises approximately the 65% of the internal module 1 and the external layer 6 comprises approximately the 35% of the encapsulated insulating module.

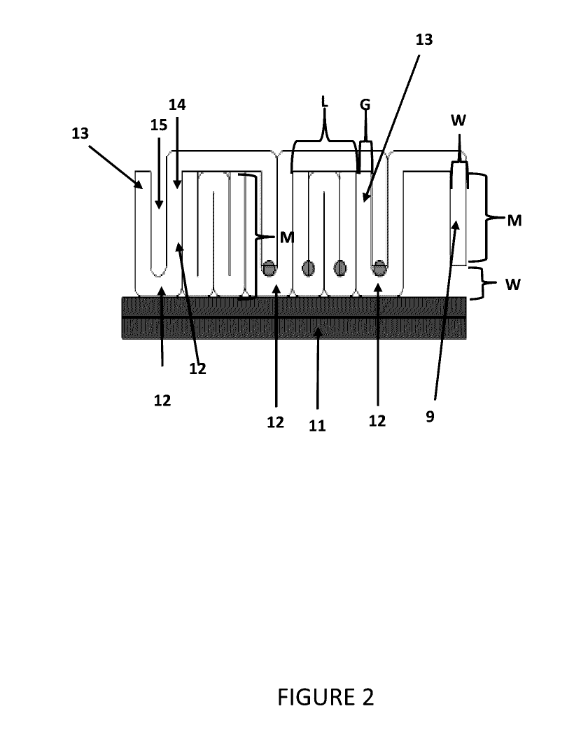

In a second embodiment of the invention, the external layer 6 of each encapsulated module is shaped in such way, that it allows other encapsulated modules to be joined to each other as shown in FIG. 2, which are shown contacting the hot surface 11 of a furnace wall.

In said second embodiment the first portion of the external layer 6 surrounding the first lateral surface portion 4 of the internal module 1 is folded in a “U” shaped way, in such way that it creates a “U” shaped portion 12 having a first leg 13, a second leg 14 and a slot 15 between them. The first portion 7 that surrounds the cold surface portion 3 of the internal module 1 has a length equivalent to the length “L” of the internal module 1 plus the width “W” of the external layer 6 in such way that a gap “G” is formed between the second lateral surface portion 5 of the internal module 1 and the third portion 9 of the external layer 6 that surrounds the second lateral surface portion 5, wherein said gap “G” has a width equal to the width “W” of the ceramic fiber blanket that forms the external layer. Finally the length “E” of the third portion 9 that surrounds the second lateral surface portion is equal to the total width “M” of the internal module minus the width “W” of the ceramic fiber blanket that forms the external layer 6.

Wherein the third portion 9 that surrounds the second lateral surface portion 5 of a first encapsulated module is tightly received in the slot 15 of the “U” shaped portion 12 of a second encapsulated module and the first leg 13 of the “U” shaped portion 12 of the second encapsulated module is tightly received inside the gap “G” of the first encapsulated module and so forth with additional encapsulated modules, thus joining them together.

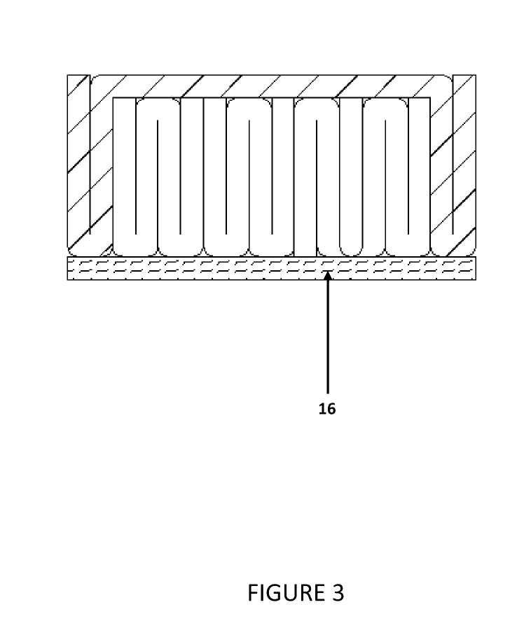

In a third embodiment of the invention, a third layer 16 made of a ceramic fiber blanket may be included below the encapsulated module as shown in FIG. 3. Finally, it must be understood that the encapsulated insulating module of the present invention is not limited exclusively to the embodiments above described and illustrated, and that the persons having ordinary skill in the art would be able, with the teaching provided by the invention, to make modifications to the design and component distribution of the encapsulated insulating module of the present invention, which will clearly be within of the true inventive concept and of the scope of the invention which is claimed in the following claims.

1. An encapsulated insulating module for furnaces comprising:
an internal module made of an insulating material, said internal module having: a hot surface portion contacting the hot surface of a furnace wall, a cold surface portion opposite to the hot surface portion, a first lateral surface portion and a second lateral surface portion;
an external layer made of an insulating material blanket having a first portion surrounding the cold surface portion of the internal module, a second portion surrounding the first lateral surface portion of the internal module and a third portion surrounding the second lateral surface portion of the internal module.

2. An encapsulated insulating module as claimed in claim 1, wherein the first portion of the external layer that surrounds the first lateral surface portion of the internal module and the second portion of the external layer that surrounds the second lateral surface portion of the internal module may be long enough to be folded over themselves in one or more “U” shaped turns.

3. An encapsulated insulating module as claimed in claim 1, wherein:
the first portion of the external layer surrounding the first lateral surface portion of the internal module is folded in a “U” shaped way, in such way that it creates a “U” shaped portion having a first and a second leg and a slot between them;
the first portion that surrounds the cold surface portion of the internal module has a length equivalent to the length of the internal module plus the width of the external layer in such way that a gap is formed between the second lateral surface portion of the internal module and the third portion of the external layer that surrounds the second lateral surface portion, wherein said gap has a width equal to the width of the external layer;
the length of the third portion that surrounds the second lateral surface portion is equal to the total width of the internal module minus the width of the ceramic fiber blanket that forms the external layer; and
the third portion that surrounds the second lateral surface portion of a first encapsulated module is tightly received in the slot of the “U” shaped portion of a second encapsulated module and the first leg of the “U” shaped portion of the second encapsulated module is tightly received inside the gap of the first encapsulated module and so forth with additional encapsulated modules, thus joining them together.

4. An encapsulated insulating module as claimed in claim 1, wherein the internal module is made of a regular quality ceramic fiber.

5. An encapsulated insulating module as claimed in claim 1, wherein the internal module is made of a regular quality ceramic fiber formed by folding an individual ceramic fiber strip or blanket, which is in unfolded condition, in a manner doubling the ends over on themselves forming “U” shaped turns.

6. An encapsulated insulating module as claimed in claim 1, wherein the external layer is made of a high quality, high performance ceramic fiber, formed by a ceramic fiber strip.
